(19) United States
(12) Patent Application Publication
(10) Pub. No.: US 2002/0160183 A1
(43) Pub. Date: Oct. 31, 2002

(54) Sticker

(75) Inventor: Youichi Hanakawa, Osaka (JP)

Correspondence Address: LOWE HAUPTMAN GOPSTEIN & BERNER, LLP, Suite 420, 99 Canal Center Plaza, Alexandria, VA, 22314, US

(73) Assignee: KOKUYO CO., LTD.

(21) Appl. No.: 10/073,040

(22) Filed: Feb. 12, 2002

(30) Foreign Application Priority Data
Apr. 26, 2001 (JP) 2001-130387

(51) Int. Cl. B32B 15/04; B32B 3/00; B32B 27/14; B32B 7/12

(52) U.S. Cl. 428/343

(57) ABSTRACT

A sticker is formed by providing a first adhesive layer 12 on one end side of one face of a sheet piece 11 formed in a substantially square plane shape in a plan view and a second adhesive layer 13 on the other end side of the sheet piece 11. The second adhesive layer 13 is formed at an inward distance of about 15 mm or more from the other end of the sheet piece 11 to form a gap S of such a size that the sheet piece 11 can be attached flat on a face AS of an object A to which the sheet piece 11 is to be attached and that the sheet piece 11 can be easily peeled off.

### BACKGROUND OF THE INVENTION

1. Field of the Invention

The present invention relates to a sticker and more specifically to a sticker, an attached state of which can be maintained as flat as possible and which can be easily peeled off.

2. Description of the Related Art

Conventionally, there is known a sticker formed by providing an adhesive layer on one face of a sheet piece. Because a pressure sensitive adhesive by which the sticker can be attached again without transference of the adhesive to an object to which the sticker is attached is used as an adhesive forming the adhesive layer of the sticker, the sticker is widely used as a marking implement for office work or study. Such sticker is commercially available as a laminated body of a plurality of sheet pieces each provided with an adhesive layer in an area on one end side of one face of the sheet piece in a substantially square shape in a plan view and a user peels the stickers off one by one and stick them on object portions.

However, because the adhesive layer is provided on the one end side of the one face of the sheet piece in the conventional sticker, when the sticker is attached on the object such as a container in a three-dimensional shape or a face of a blackboard or the like, the other end side without the adhesive layer is separated from the object by a large distance, an attached state is not maintained flat, and visibility of letters or the like is poor when the letters or the like are written on the sticker.

Therefore, recently, as shown in FIG. 7, a sticker 50 in which an adhesive layer is also provided on the other end side opposite to a position where the adhesive layer is provided is commercially available. With this arrangement, the sticker 50 can be attached to a face AS of an object A in a substantially close contact with the face AS by the first and second adhesive layers 53 and 54 provided to the one end side and the other end side of the sheet piece 51 forming the sticker 50 as shown in FIG. 3(B).

However, because the second adhesive layer 54 provided on the other end side is very close to the other end of the sheet piece 51 in the sticker 50, it is not easy to recognize an end edge from which the sticker is peeled off the uppermost sticker when the stickers are formed into a laminated body and therefore, it is difficult to peeled off the stickers one by one. Moreover, a gap S for inserting a fingertip between the face AS of the object A and the other end of the sheet piece 51 is very small when the sicker is attached to the object A as shown in FIG. 3(B), which obstructs peeling off of the sticker 50. Furthermore, in use in which a plurality of stickers 50 are arranged and attached to a straight line without attaching each other as shown in FIG. 4(B), an entire length of the stickers 50 becomes very long.

### SUMMARY OF THE INVENTION

The present invention has been accomplished by paying attention to the above problems and it is an object of the invention to provide a sticker which can be attached in a flat state and can be handled preferably in peeling and by which an entire length of a plurality of stickers arranged and attached in a direction of a straight line can be suppressed.

To achieve the above object, the invention adopts a structure of a sticker comprising a first adhesive layer on one end side of a sheet piece formed into a predetermined plane shape and a second adhesive layer on the other end side of the sheet piece,

wherein the second adhesive layer is provided inside the other end of the sheet piece and in such a position as to maintain a substantially plane-contact state when the sheet piece is attached to a predetermined object to which the sheet piece is to be attached and to maintain ease of peeling from the other end. To put it concretely, a structure in which the second adhesive layer is provided at an inward distance of about 15 mm or more from the other end of the sheet piece is adopted. With this arrangement, the sticker can be attached to the object in the substantially flat state by the first and second adhesive layers. On the other hand, in peeling the attached sticker, it is relatively easy to insert a fingertip between the other end and the object. When a plurality of stickers are attached in a line in a direction of a straight line without sticking each other, it is possible to suppress an increase in an entire length of the plurality of attached stickers. The reason why the second adhesive layer is provided in a position at the inward distance of about 15 mm from the other end of the sheet piece is that almost no gap is formed between the other end of the sheet piece and the object and the sheet piece is hard to peel when the distance is smaller than 15 mm.

In the sticker of the invention, it is also possible to further provide an adhesive layer between the first and second adhesive layers. Because adhesive force acting on the object becomes stronger when the adhesive layer is provided to an intermediate portion, it is possible to further stably attached the sticker.

A length of an area between an end edge on the other end side of the second adhesive layer and the other end can be set to be about one-fifth or more of a length of the sheet piece and is more desirably set to be about one-third or more of the length of the sheet piece. This is because the sticker is hard to peel from the other end side when the sticker is attached to the object if the length of the area is smaller than one-fifth. If the length of the area is one-third or more, it is possible to more effectively suppress the entire length of the stickers when the stickers are arranged on the straight line. Furthermore, if the second adhesive layer is provided in a shape of a thin strip in an area at a distance of one-third or more and less than two-thirds from the other end, the plane-contact state can be maintained, a length of the stickers arranged on the straight line can be suppressed, ease of peeling of the sticker can be obtained, and the sticker is less liable to be curved in a rolled shape after the sticker is peeled off.

### BRIEF DESCRIPTION OF THE DRAWINGS

FIG. 1 is a perspective view of a sticker according to a first embodiment;

FIG. 2 is a plan view of FIG. 1;

FIG. 3(A) is an explanatory view of a state in which the sticker is attached to an object on which the sticker is to be attached;

FIG. 3(B) is an explanatory view of a state in which a conventional sticker is attached similarly;

FIG. 4(A) is an explanatory view of a state in which a plurality of stickers of the embodiment are arranged and attached to a straight line;

FIG. 4(B) is an explanatory view of a state in which the conventional stickers are attached similarly;

FIG. 5 is a plan view of a sticker according to a second embodiment;

FIG. 6 is a plan view of a sticker according to a third embodiment; and

FIG. 7 is a plan view of a conventional sticker.

### DETAILED DESCRIPTION OF THE PREFERRED EMBODIMENTS

Embodiments of the present invention will be described below with reference to the drawings. In the following description, “length” refers to a direction along a lateral direction in FIG. 2 while “width” refers to a direction along a vertical direction in FIG. 2.

[First Embodiment]

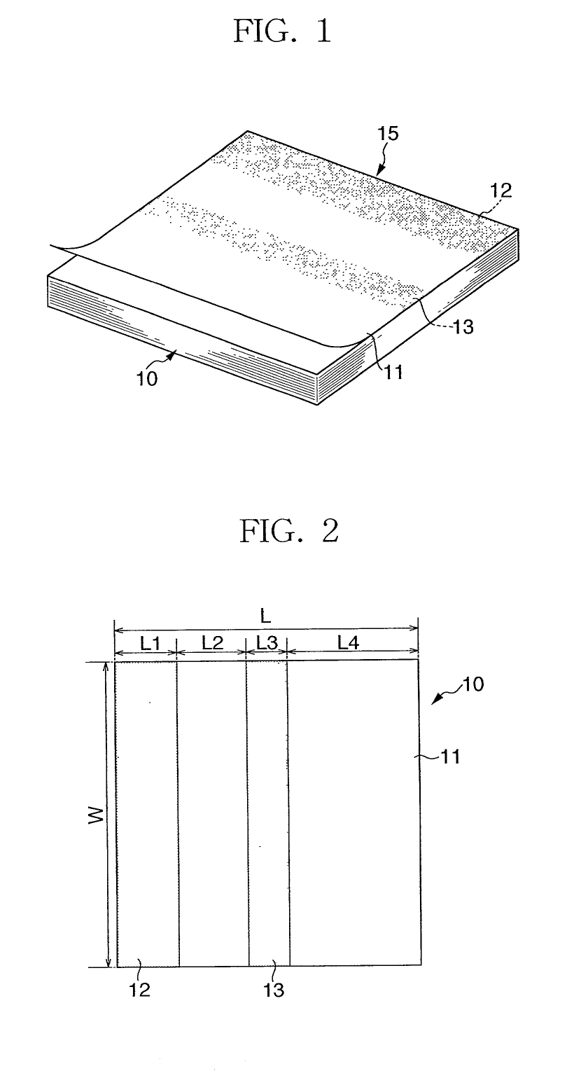

FIGS. 1 and 2 show a first embodiment of a sticker according to the invention. In the drawings, the sticker 10 is formed of a sheet piece 11 in a substantially square shape in a plan view and provided with first and second adhesive layers 12 and 13. By piling a plurality of sheet pieces, a sticker laminated body 15 is formed. It is possible to successively peel an uppermost sticker 10.

Each the sheet piece 11 forming the sticker 10 is in a square shape having a length L and a width W of about 74 mm as shown in FIG. 2 in the present embodiment. The first adhesive layer 12 is provided to one face on one end side in a length direction and the second adhesive layer 13 is provided to one face on the other end side in the length direction. A length L1 of the first adhesive layer 12 is about 15 mm and the second adhesive layer 13 having a length L3 of about 10 mm is provided in a position at a distance L2 of about 17 mm from a right end of the first adhesive layer 12. A length L4 from a right end of the second adhesive layer 13 to a right end of the sheet piece 11 is about 32 mm, an adhesive layer is not provided in this L4 area, and the L4 area functions as a margin to be peeled.

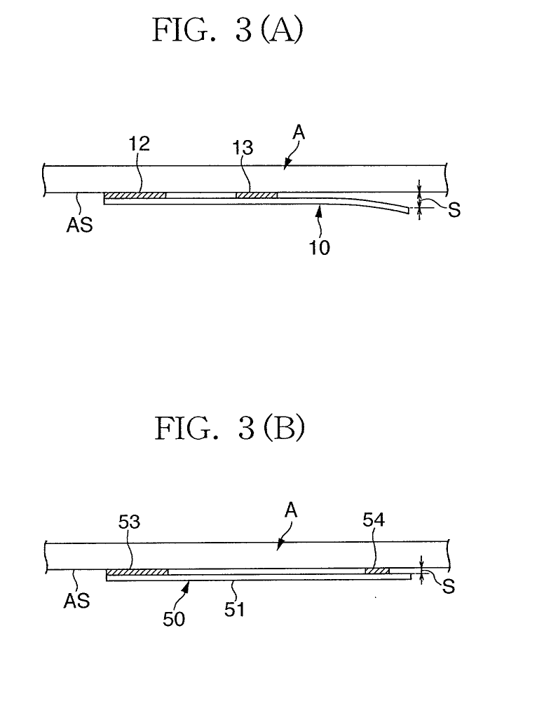

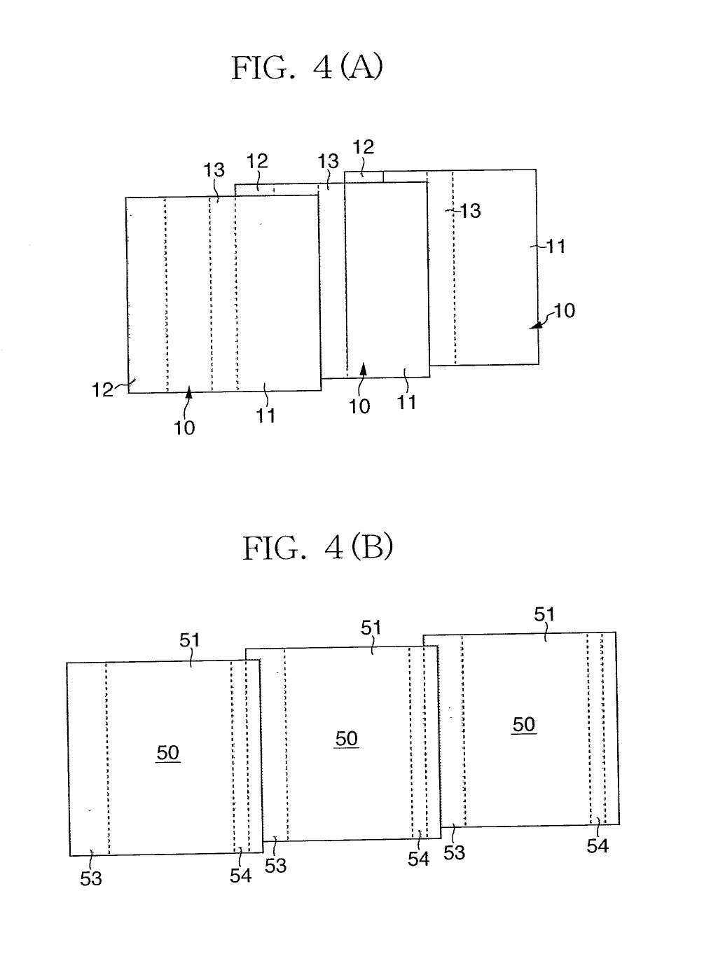

In attaching the above sticker 10, the sticker 10 can be attached or stuck flat on a face AS of an object A on which the sticker 10 is to be attached through the first and second adhesive layers 12 and 13 as shown in FIG. 3(A) and preferable visibility of letters and the like written on a surface of the sticker 10 can be maintained. Moreover, it is possible to form a gap S of such a size that the sticker 10 can be easily peeled off as compared with a sticker of a conventional type between the right end of the sticker 10 and the face AS of the object A. Furthermore, when a plurality of stickers 10 are attached to a straight line without sticking each other as shown in FIG. 4(A), it is possible to reduce an entire length as compared with a conventional type shown in FIG. 4(B). When the uppermost sticker 10 is peeled off in a state of the sticker laminated body 15 shown in FIG. 1, it is possible to easily recognize an end portion from which the sticker 10 can be peeled off.

[Second Embodiment]

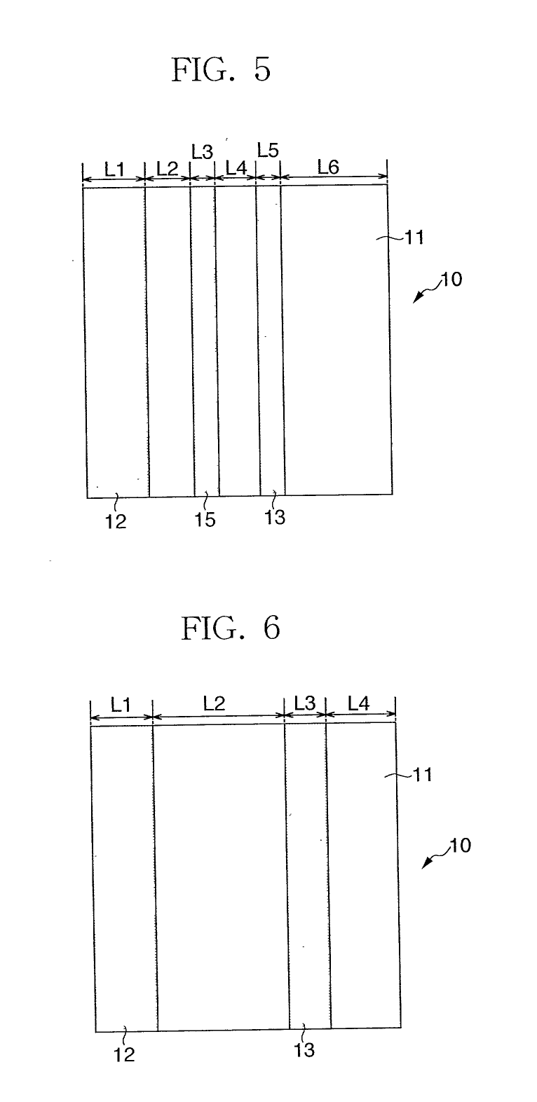

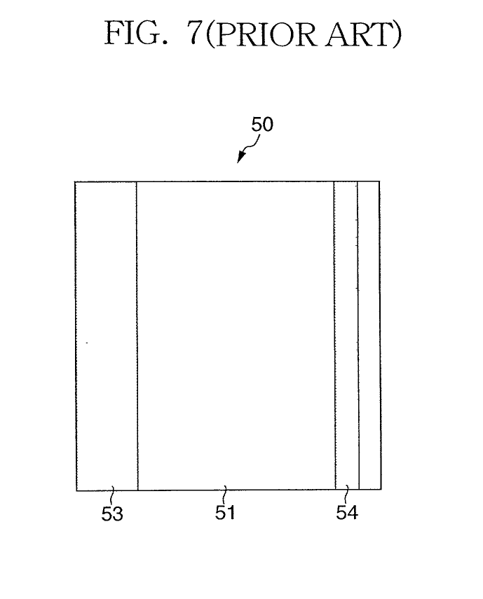

FIG. 5 shows a sticker 10 according to a second embodiment of the invention. The sticker is characterized in that a third adhesive layer 15 is provided between a first adhesive layer 12 and a second adhesive layer 13 and a length L6 between the second adhesive layer 13 and a right end of a sheet piece 11 is set at about 26 mm. A plane size of the sheet piece 11 (i.e., a length and a width) in the embodiment is substantially the same as that in the first embodiment. In FIG. 5, lengths L1, L2, L3, L4, and L5 are respectively set at 15 mm, 11 mm, 6 mm, 10 mm, and 6 mm.

In the second embodiment, larger adhesive strength acting on the object can be obtained by the first to third adhesive layers 12, 13, and 15 as compared with the first embodiment and the sticker 10 can be attached more flatter because the length L6 is smaller.

[Third Embodiment]

FIG. 6 shows a third embodiment of the invention. This embodiment is characterized in that a length L4 between a second adhesive layer 13 and a right end of a sheet piece 11 is set at about 17 mm. A plane size of a sticker 10 is the same as that of each the above embodiment. In FIG. 6, lengths L1, L2, and L3 are respectively set at 15 mm, 32 mm, and 10 mm.

According to this embodiment, while the sticker 10 can be attached flatter than the second embodiment, ease in peeling the sticker 10 is not impaired extremely, and practical use can be obtained.

The plane size of the sticker 10 in the invention is not limited to that in the above embodiments and various types with different lengths L and widths W can be employed. Not only the third adhesive layer 15 but also more layers can be provided between the first and second adhesive layers 12 and 13. Although the second adhesive layer is formed as a strip extending in a width direction, the second adhesive layer can be formed as a spot or as scattered areas. In short, in the invention, the length and the width of the adhesive layer can be changed arbitrarily as long as the sticker can be attached in a flat state and can be easily peeled off.

As described above, according to the invention, because the second adhesive layer is provided in such a position that a substantially plane-contact state is maintained when the sheet piece is attached on the predetermined object and that ease of peeling from the other end is maintained, it is possible to attach the sticker substantially flat on the object through the first and second adhesive layers and preferable visibility of a predetermined writing on the sticker can be maintained. It is possible to form the gap of the proper size which facilitates insertion of a fingertip between the sticker and the object when the attached sticker is peeled. Furthermore, when the plurality of stickers are attached in a line in the direction of the straight line without attaching each other, it is possible to suppress an increase in the entire length of the plurality of attached stickers.

When the adhesive layer is further provided between the first and second adhesive layers, adhesive force acting on the object becomes stronger and stabler attaching can be achieved.

Moreover, by the structure in which the length of the area between the end edge on the other end side of the second adhesive layer and the other end is set to be about one-fifth or more and more desirably one-third or more of the length of the sheet piece, it is possible to stably obtain attaching of the sticker in the plane-contact state and ease of peeling. Therefore, it is possible to provide the sticker as a sticker especially suitable for being attached to a face of a whiteboard and the like or being attached in a large number of positions on a face of a sheet of simili paper and the like, for example.

What is claimed is:

1. A sticker comprising a first adhesive layer on one end side of a sheet piece formed into a predetermined plane shape and a second adhesive layer on the other end side of the sheet piece,
wherein the second adhesive layer is provided inside the other end of the sheet piece and in such a position as to maintain a substantially plane-contact state when the sheet piece is attached to a predetermined object to which the paper leaf is to be attached or stuck and to maintain ease of peeling from the other end.

2. A sticker comprising a first adhesive layer on one end side of a sheet piece formed into a predetermined plane shape and a second adhesive layer on the other end side of the sheet piece,
wherein the second adhesive layer is provided at an inward distance of about 15 mm or more from the other end of the sheet piece and in such a manner as to maintain a substantially plane-contact state when the sheet piece is attached to a predetermined object on which the sheet piece is to be attached and to maintain ease of peeling from the other end.

3. The sticker according to claim 1 or 2, wherein an adhesive layer is further provided between the first and second adhesive layers.

4. The sticker according to any one of claims 1 to 3, wherein a length of an area between an end edge on the other end side of the second adhesive layer and the other end is set to be about one-fifth or more of a length of the sheet piece.
